(19) United States
(12) Patent Application Publication
(10) Pub. No.: US 2002/0003889 A1
(43) Pub. Date: Jan. 10, 2002

(54) Headphone device with improved controls and/or removable memory

(76) Inventor: Addison M. Fischer, Naples, FL (US)

Correspondence Address: NIXON & VANDERHYE P.C., 8th Floor, 1100 North Glebe Road, Arlington, VA, 22201, US

(21) Appl. No.: 09/837,551

(22) Filed: Apr. 19, 2001

Related U.S. Application Data
(60) Provisional application No. 60/198,379, filed on Apr. 19, 2000.

(51) Int. Cl. H04R 25/00

(52) U.S. Cl. 381/370

(57) ABSTRACT

A headphone system is provided that incorporates a removable memory card and memory card reader in an earpiece of the headset, in addition to a speaker. The other earpiece of the headset is used to house, in addition to a speaker, a power supply for the system, such as batteries. Various control devices are provided on the outside of the earpieces for enabling the user the control the playback, such as start/stop, power, volume, track, forward and reverse. In another embodiment, the memory media playback device and power supply, as well as all of the controls, are incorporated into the headband that connects the two earpieces. A microphone may also be used on the headset to enable the device to be used for dictation as well as playback of audio. A further embodiment is provided wherein a remote playback device is used to send wireless signals to the headset and/or receive wireless signals from the headset.

### FIELD OF THE INVENTION

The present invention relates to headphones and, more particularly, to an headphone system with improved controls and/or a removable memory that can be used for playback and/or recording of audio.

### BACKGROUND AND SUMMARY OF THE INVENTION

While engaged in various activities, such as walking, exercising, relaxing or the like, many people enjoy listening to pre-recorded audio material through headphones using devices such as conventional portable tape cassette or compact disc players. The headphones used in such conventional tape or disk players are typically attached using audio cables or wires to the playback device which is typically carried by the user in a pocket or otherwise attached to the user belt or other garment. In other words, the playback device is separate from the headphones but is physically attached thereto via wires that are used to channel the audio output from the playback device to the speakers in the headset. The playback device is typically a device that enables playback and/or recording of a cassette or compact disk or other available type of storage medium.

In these conventional portable playback devices (such as a Sony Walkman®), the existence of the physical connection (i.e., wires) between the headphones and the playback device can be burdensome and annoying. For example, the wire or cord can become tangled or can catch on an object and thereby interfere with the use and enjoyment of such devices. In other words, having to maintain a wired connection between the playback device and the headphone or headset can be clumsy and inconvenient, particularly when engaged in physical activities. Moreover, having to carry the playback device in the hands of the user or by connecting the device to a user's clothing or body part can also be problematic in many situations. In fact, many users of such playback devices use a special carrier device or accessory, such as a hip, waist or arm belt, that is designed to enable the device to be more easily carried by the user during operation. In addition to the disadvantage of the added expense for such accessories, placing the playback device in the accessory (such as a pocket or holder) often makes it difficult to operate the controls on the playback device, such as the on/off and/or volume controls. Thus, while conventional playback devices have become very popular, further improvements are still needed that will make is them more convenient in operation as well as enhance the functionality thereof. This instant invention addresses this need by providing a new and improved headset/playback device which eliminates the troublesome wired connection and streamlines the use of headphones.

In accordance with one embodiment of the invention, a headphone system is provided that incorporates a removable memory card and memory card reader in an earpiece of the headset, in addition to a speaker. The other earpiece of the headset is used to house, in addition to a speaker, a power supply for the system, such as batteries. Various control devices are provided on the outside of the earpieces for enabling the user the control the playback, such as start/stop, power, volume, track, forward and reverse. In another embodiment, the memory media, playback device and power supply, as well as all of the controls, are incorporated into the headband that connects the two earpieces. A microphone may also be used on the headset to enable the device to be used for dictation as well as playback of audio. A further embodiment is provided wherein a remote playback device is used to send wireless signals to the headset and/or receive wireless signals from the headset.

### BRIEF DESCRIPTION OF THE FIGURES

These and other objects, features and advantages of the instant invention will become apparent from the following detailed description of the invention when read in conjunction with the appending drawings, in which:

FIG. 1 is a right-side perspective view of a first embodiment of the headphone system of the instant invention;

FIG. 2 is a left-side perspective view of the headphone system of FIG.

FIG. 3 is a plan view of the right-side of the headphone system of FIG. 1;

FIG. 4 is a sectional view of the right-side earpiece of the headphone system of FIG. 3;

FIG. 5 is a plan view of the left-side of the headphone system of FIG. 1;

FIG. 6 is a sectional view of the left-side earpiece of the headphone system of FIG. 5;

FIG. 7 is a front plan view of a second embodiment of the headphone system of the instant invention;

FIG. 8 is a plan view of right-side of the headphone system of FIG. 7;

FIG. 9 is a rear plan view of the headphone system of FIG. 7

FIG. 10 is a plan view of the left side of the headphone system of FIG. 7;

FIG. 11 is a top plan view of the headphone system of FIG. 7;

FIG. 12 schematically shows a third embodiment of the headphone system of the instant invention; and

FIG. 13 schematically shows a fourth embodiment of the headphone system of the instant invention.

### DETAILED DESCRIPTION OF THE PREFERRED EMBODIMENTS

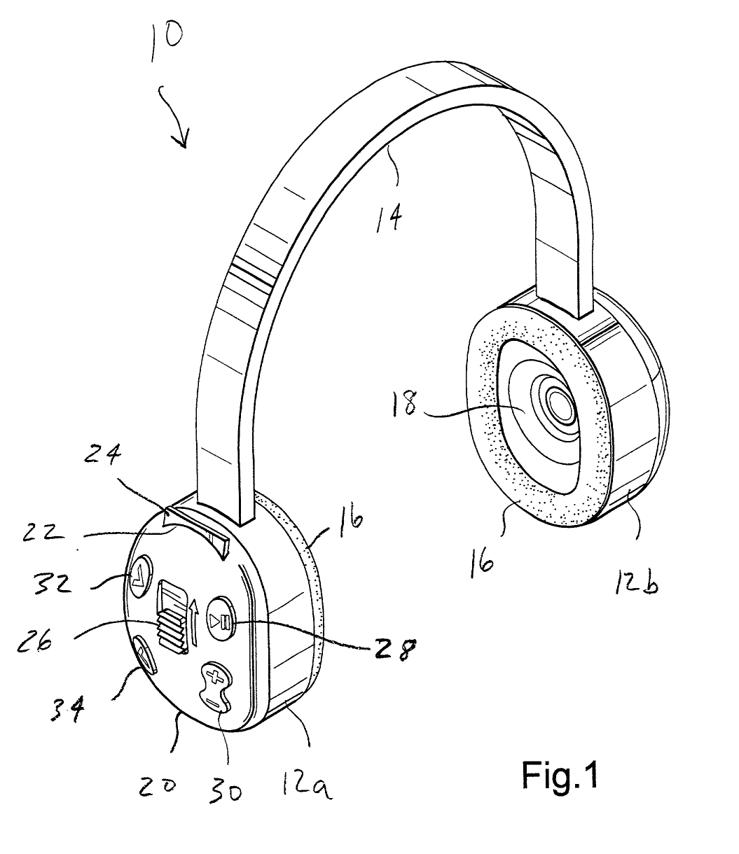

Referring now to the drawings, wherein like reference numerals designate similar parts throughout the various views, FIG. 1 shows a first embodiment of the headphone system of the instant invention. In accordance with this embodiment, the headphone system constitutes a self-contained playback system wherein all of the parts necessary for playback to the user are contained in the headset itself. In other words, in accordance with this embodiment of the instant invention, a separate playback unit or device is not needed and, as a result, no external wires are needed to connect the playback device to the headphones. Thus, the headphones can be easily and conveniently worn by a user without experiencing the disadvantages and inconveniences associated with conventional wired-connection portable playback systems.

As shown in FIG. 1, the headphone system 10 of this first embodiment includes a pair of earpieces 12a and 12b connected by a headband 14, so that the headphone system can be worn on the head of a user like a conventional headset. Like a conventional headset, each of the earpieces 12a and 12b includes a speaker 18, as well as foam padding 16 that enables the earpieces to fit comfortably and securely over the ears of a user. The speakers 18 are sized and configured to enable high quality audio signals to be heard by the user when audio signals are provided thereto.

In accordance with this embodiment of the instant invention, one of the earpieces 12a incorporates a playback device and a removable memory medium therein. Preferable the memory medium is a solid-state memory 24 and the playback device is suitably adapted (i.e., includes appropriate accessing circuitry) to read the particular memory 24. However any suitable memory may be used, including, but not limited to, optical, electric, magnetic or any combination thereof. Thus, audio information, such as music, can be stored on the memory 24 and played to the user through the headphone system 10. The earpiece 12a preferably includes a slot 22 in the housing 20 of the earpiece that enables the memory medium 24 to be inserted and removed from the earpiece. Thus, the memory 24 can be removed from the earpiece and used with another device (such as a computer) to download music or other audio information thereon. The memory medium 24 can then be placed back in the headset so that the downloaded audio information can be played to the user when wearing the headphones. An eject button 26 is provided for enabling the user to eject the memory 24 from the earpiece 12a.

In addition to holding the memory 24, the earpiece 12a also includes controls for the payback device contained in the earpiece 12a. For example, as shown in FIG. 1, the controls preferably include a stop/start button assembly 28, a volume control assembly 30 for both increasing and decreasing the volume of the audio output, a fast forward button assembly 32 for fast forwarding the audio information, and a first backwards button assembly for fast backing-up the audio information. Thus, by inserting the memory 24 into the earpiece 12a and pressing the start button 28, the headphones will play the audio information to the wearer of the headphones, and the wearer can easily control the audio playback by manipulating the various controls 28, 30, 32 and 34.

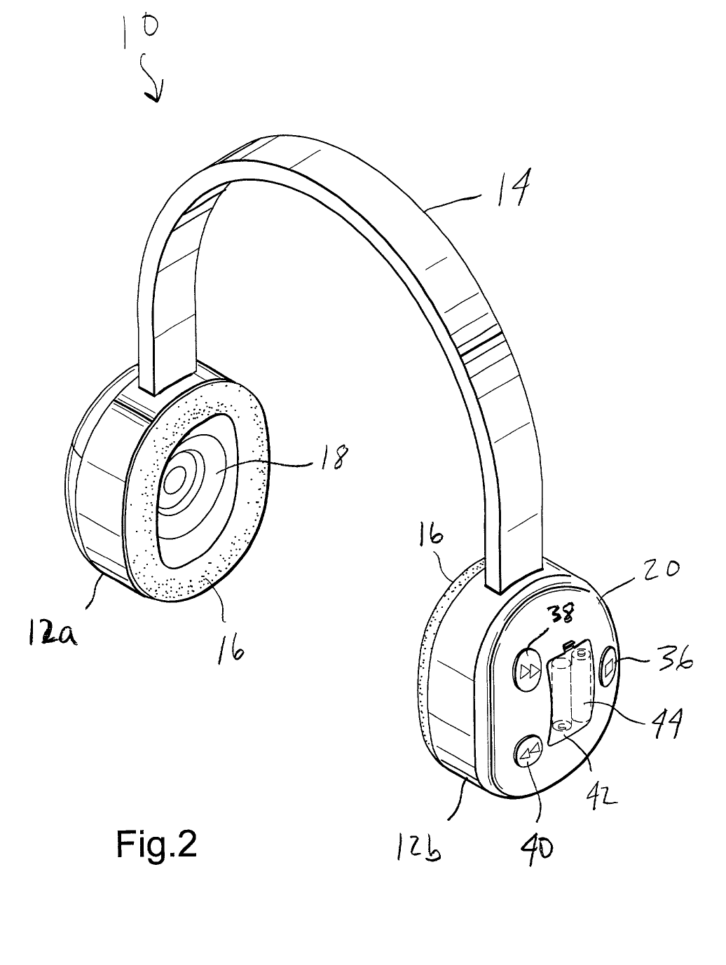

Referring now to FIG. 2, the other earpiece 12b of the headphone system 10 includes a battery compartment 42 built into the housing 20 of the earpiece, thereby enabling batteries 44, or other suitable power supply, to be inserted into the device for powering the headphone system. In addition to the power supply, the earpiece 12b preferably also includes a power button assembly 36, such as a toggle switch, for powering on and off the headphone system. The earpiece 12b may also include a next track assembly 38 and previous rack assembly 40 for enabling the next or previous tracks to be selected by respective operation thereof.

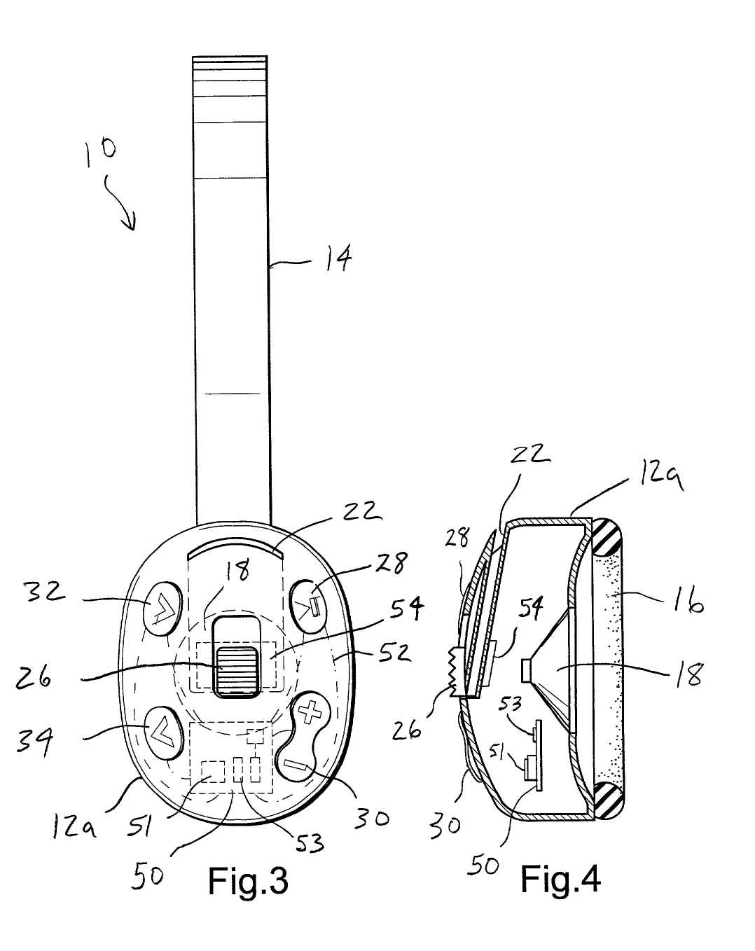

Referring now to FIGS. 3 and 4, the earpiece 12a is shown in more detail. A memory card reader 54, or other suitable accessing circuitry, is provided such that the memory 24 can be read by the headphone system when inserted in the slot 22. A processor/logic assembly 50 is also included in the earpiece for controlling the operation of the headphone system. All of the various control assemblies/buttons are connected to the processor/logic assembly 50 via wiring 52 and are controlled thereby. The processor/logic assembly preferably includes a microprocessor 51 and one or more local memories 53 for use by the processor in operating and controlling the headphone system.

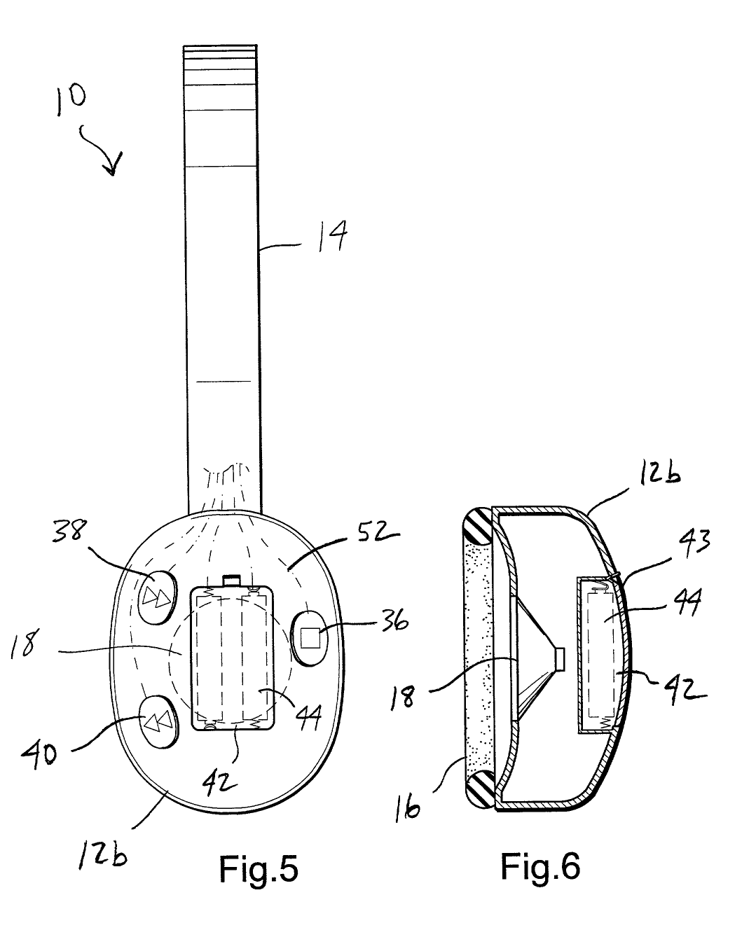

Referring now to FIGS. 5 and 6, the earpiece 12b is shown in more detail. Again, this earpiece includes the batteries 44 in compartment 42, as well as additional controls 36, 38 and 40 as described above. The power supply 44 and the controls are all wired to the processor/logic assembly in the other earpiece 12a using wires 52 that extend through the interior of the headband 14, thereby interconnecting all of the functional features of the two earpieces 12a and 12b so that they work as a single playback unit. A removable cover 43 is also provided for opening and closing the battery compartment 42 so that batteries can be inserted and removed therefrom as needed.

As explained in detail above, in the exemplary embodiment of FIGS. 16, the headset unit comprises both the earphones and the playback equipment together in a single device. Preferably, the audio material itself is stored, either optically or electro-magnetically in solid-state memory 24. Such memory 24 may reside permanently in the device, or may be removable so that different memory elements can be exchanged and used in the headphone system. Alternatively, the headphone system may include the ability to use more than one type of memory, or may facilitate different formats of removable solid state memories. For example, the headphone system may include reading equipment for both the Toshiba SmartMedia and the SanDisk Multimedia cards, thereby enabling either or both of these memories to by used in the system.

The various components of the device such as the batteries, the memory and/or the memory reader, the processor, and the various control mechanisms (e.g., buttons or switches) may be positioned in a variety of locations on the headset. Thus, the configuration shown in FIGS. 1-6 is only one embodiment and other configurations can be used as desired. In one exemplary embodiment, power is provided by two removable AAA batteries 44 located within the left earpiece 12b. As explained above, audio performances are presented to the device through removable memory cards (e.g., Toshiba SmartMedia or SanDisk Multimedia)) which are inserted into the memory card reader, the slot 22 for which is located in the right earpiece 12a, as explained above. Of course, other arrangements are possible, such as swapping the functionality of the right and left earpieces described above.

As explained above, the embodiment of FIGS. 1-6 has various controls which are present on the device for controlling the operation of the headphone system 10 in a convenient and easy manner. For example, the power on/off control button 36 is preferably located at the back of the left earpiece 12b, so that it can be easily operated by the left hand of the operator to turn on and off the power to the headphone system. The fast backward control button 34, which moves the moment of play backward like a tape rewind, is located at the bottom of the back of the right earpiece 12a. The fast forward control 32 which accelerates play like a “fast forward” on a tape device, is located at the top of the back of the right earpiece 12a. Preferably, fast forward and fast backwards buttons move the performance forward or backwards at an accelerated rate as long as the button is being pressed. The Play/Pause control 28 (which toggles audio play between pause and resume) is located near the top front of the right earpiece 12a, and alternatively starts and stops the performance, leaving the position of the performance unchanged. The volume increase/decrease control 30 is conveniently located on the front of the right earpiece 12a below Play/Pause button 28. Each use of these volume controls increases/decreases the volume to the next higher/lower discrete level. The device has a series of volume levels, and each click of this control increases/decreases the volume to the next level. Alternatively, the volume controls could operate continuously, so that the volume increases/decreases continuously as long as the control is pressed. On the top and bottom respectively of the front of the left earpiece 12b are the Track Forward and Track Backward controls 38 and 40 which move the audio performance to the next or previous audio selection, similar to the “next track” and “previous track” controls on a CD player. Each use of these track controls advances play to the next/previous prescribed performance boundary (“track”) on the media.

To operate the headphone system 10 of FIGS. 1-6, the user inserts with their right hand a SmartMedia card 24 (or other suitable memory device) into the slot 22 at the top of the right earpiece 12a, turns on the headset with their left hand (On/Off), then adjusts the volume with their right hand (Volume +, Volume −). If necessary, the selection can be adjusted to the desired position using the Next/Previous track controls. To suspend operation at any time, the user simply operates the Play/Pause control to pause the performance at its current position. Unless the SmartMedia card 24 is removed, the device will resume the performance at the point of pause when the user next operates the Play/Pause control.

Preferably, there is embedded “permanent” control memory, (e.g., embedded memory 53) in addition to the removable performance memory 22, which is used to record the position of performance, the volume level, and any other operating parameters, so that the headphones will be automatically set to the appropriate or desired volume level/memory location when the headphone system is tuned on. In other words, for convenience of the user, the operating parameters are preferably saved when the power supply is tuned off for use when the unit is turned back on.

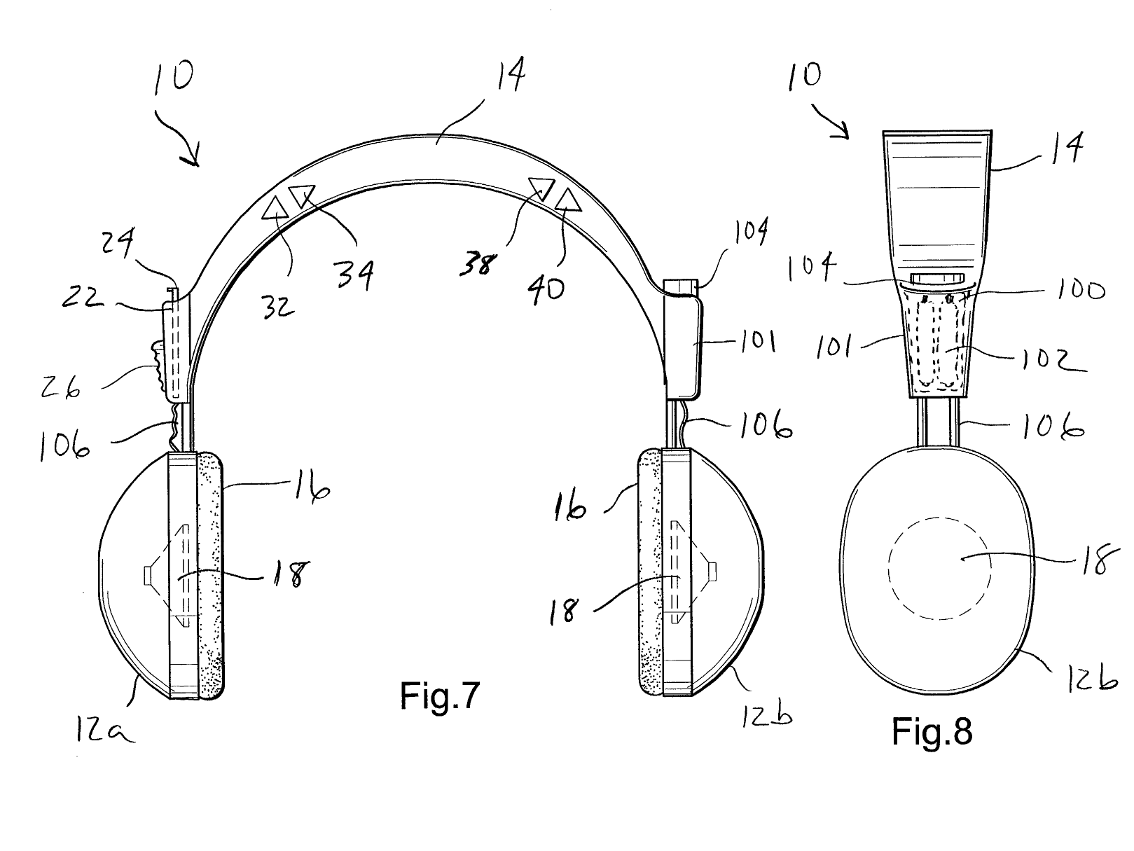

FIG. 7 shows a second embodiment of the headphone system 10 of the instant invention. This embodiment differs from the embodiment of FIGS. 16 in that the earpieces are smaller, and the battery, the user's operational controls, and the processor are located in the headband 14 connecting the earpieces, rather than in the earpieces themselves. As shown in FIG. 7 the headband 14 connects the two earpieces 12a and 12b, which in this embodiment are similar to conventional earpieces, i.e., they have a speaker 18 and foam padding/insulation for comfortably and securely enabling the earpiece to fit over the ear of the user. In this embodiment, however, the headband 14 is equipped with all of the memory, control and playback elements discussed in connection with the first embodiment. In other words, the headband 14 includes a right side having a memory slot 22 for receiving a memory card 24, or other removable memory device, as discussed above. A memory reader, like the one described above, is also provided within the right side of the headband 14 to enable the memory card to be read thereby. An eject button 26 is also provided for ejecting the memory device. As explained above, the memory device may be permanent or removable and may be implemented using any suitable technology (i.e., optical, electrical, magnetic or combination thereof). In this embodiment, the earpieces are also adjustable relative to the headband 14, via adjusters 106 to enable the headphone system to easily fit a variety of users. It is noted that the first embodiment may also include this adjustable feature.

As shown in FIGS. 7 and 8, the left side of the headband 14 includes a battery section 101, or other suitable power supply section, which has a compartment 100 therein for holding batteries 102 for powering the headphone system 10. The compartment 100 preferably includes a flip-up lid 104 for enabling the batteries 102 to be inserted and removed therefrom. While batteries are preferred, any suitable portable power supply can be used. On the front right side of the headband 14 the fast backwards 32 and fast forward 34 control buttons are provided which have the same functions as described above. Track backward and track forward buttons 38 and 40 are provided on the front left side of the headband 14 and have the same functions as described above.

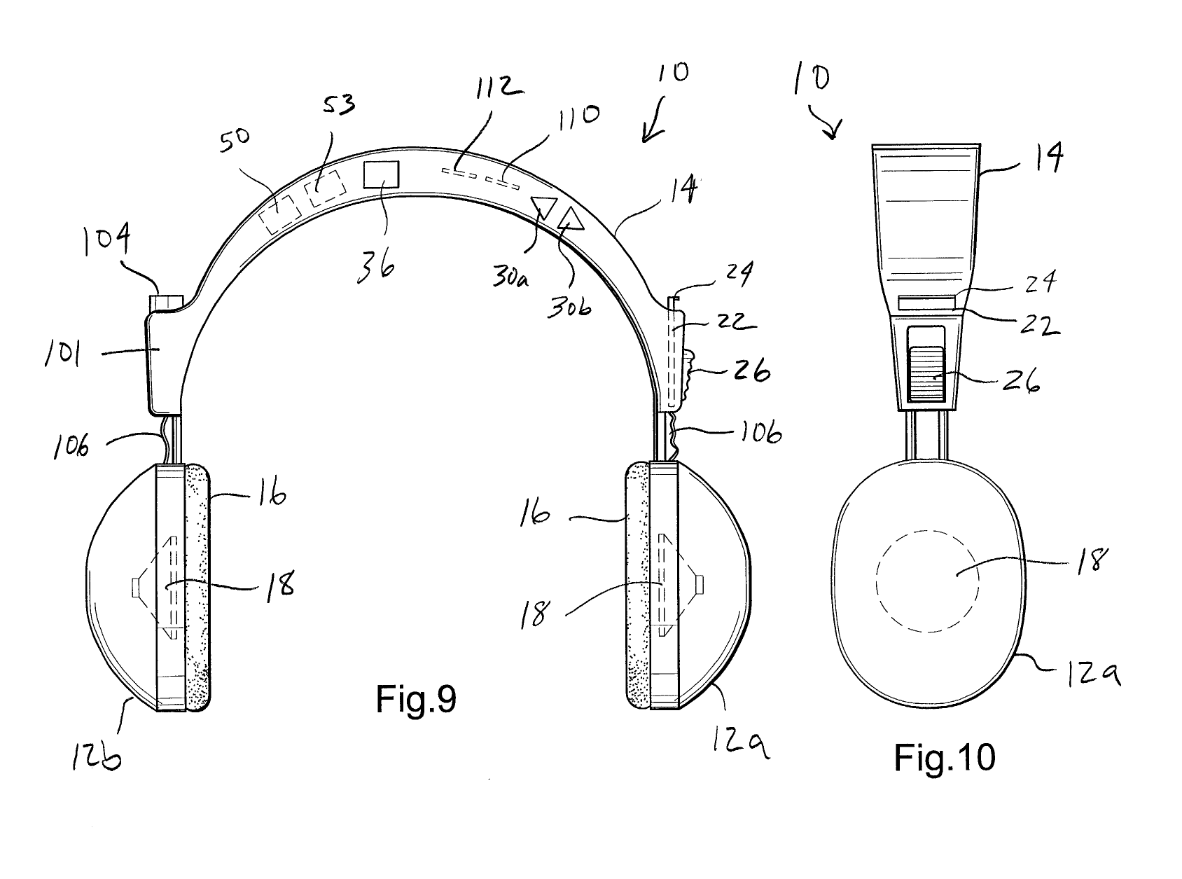

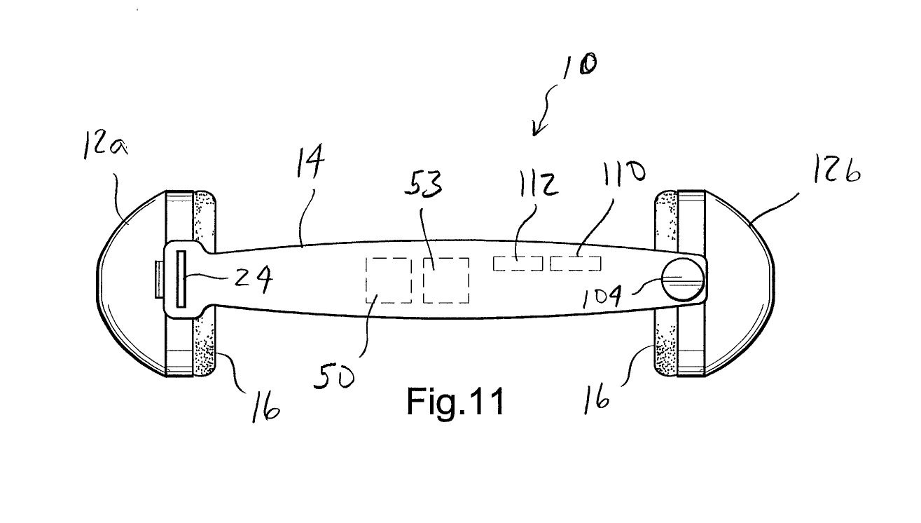

FIG. 9 shows a back view of the headphone system of FIG. 7. As shown in FIG. 9, the Start/Stop button 36 and volume control buttons 30a and 30b are provided on the back side of the headband 14. All of the control buttons preferably have the same functionality and operation as described above with respect to the first embodiment. FIG. 10 shows a side view of the right side of the headband 14 and shows the memory device 24 inserted into the memory slot 22, as well as the eject button 26. A power button (not shown) may also be provided on the headband 14 to enable powering on/off the system. A processor/logic assembly 50 is also provided in the headband 14, as seen most clearly in FIGS. 9 and 11, and has substantially the same operation as described above. Additional permanent/embedded memory units 53 may also be provided in the headband 14. This exemplary embodiment also contains a processor/control logic unit 112 that can be used to decrypt the audio information on the memory device, in the event that the information on the memory device is encrypted. Other electronic components 110 can also be included in the headband 14 as desired. As explained above, the playback device, controls, speakers and processor(s) are all connected via wires that are positioned within the interior of the headband 14. The operation of the headphone system 10 of this second embodiment is substantially the same as described above in connection with the first embodiment. The user places a memory card in the memory slot and then uses the controls on the headband to control the operation thereof. Again, the headphone system is entirely self-contained and does not require a physical or other connection to any other device for operation, thereby making it extremely convenient and portable.

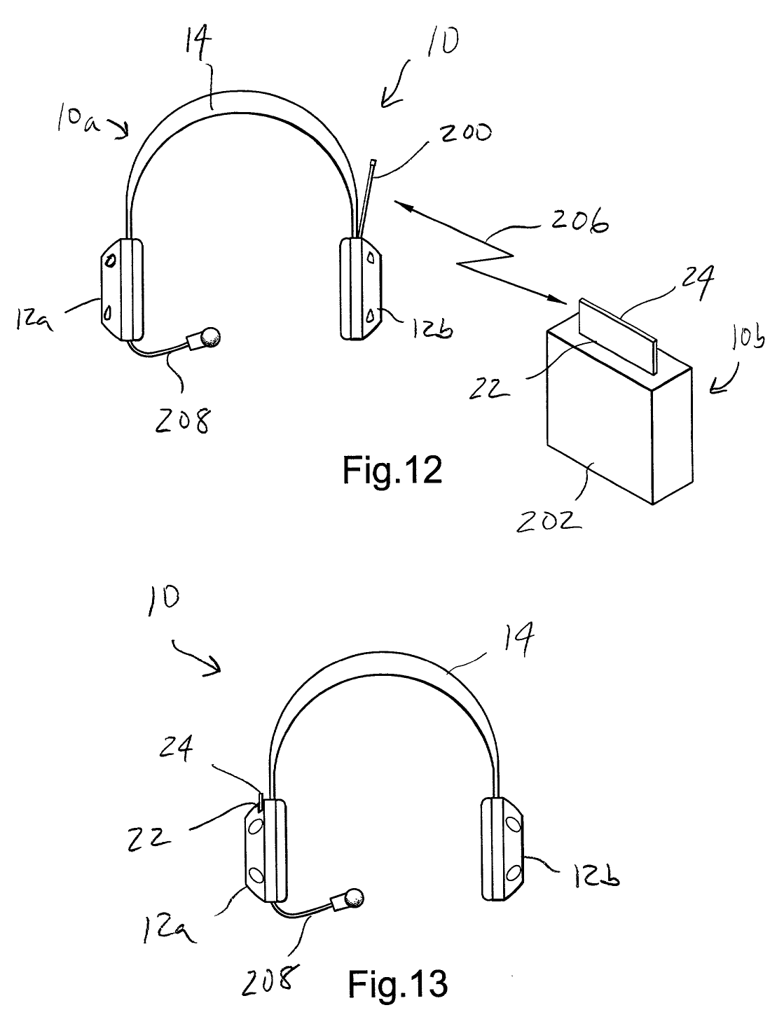

Referring now to FIG. 12, there is shown a third embodiment of the instant invention. In this embodiment the headset 10a and the media player 10b are not physically connected. In other words, the headset 10a does not include the playback device as in the other embodiments described above. Instead, a separate playback unit 10b is provided that is remote to the headset 10a. The remote unit 10b preferably includes a player unit 202 having a memory slot 22 for receiving a removable memory device as described above. In another embodiment, the memory device could be permanent. The player unit 202 includes an appropriate memory reader and other circuitry necessary for operation. A signal 206 generated by the player 10b is transmitted to the headset through low power wireless (e.g., radio) communication. In this exemplary embodiment, both the player and the head unit use batteries. The player 10b contains a transmitter which sends signals 206 to the headset 10a. The headset 10a contains a receiver designed to receive the low power signals generated by the player 10b, via antenna 200. In this exemplary embodiment, the only control on the headset is the power on/off control, which powers the receiver and the speakers in the earphones. However, other controls can be placed on the headset if desired. Preferably, the other controls discussed above, such as Forward, Backward, Pause, Start, etc., as well as Power are located on the player unit 202. This embodiment allows not only players for memory cards, but also those capable of comfortably handling larger media such as Compact Disks or tape cassettes. In other words, this embodiment is designed for use when the memory media is sufficiently large so as to make incorporation in the headset too cumbersome. As also shown in this embodiment, a permanent or removable microphone 208 may be provided together with suitable transmission electronics to enable the headphone system to be used to record the user's voice onto the memory media 24. In other words, in addition to receiving audio, the headset 10a can also send audio generated by the user to the player unit 202, so that the system could be used for dictating or the like.

FIG. 13 shows a fourth embodiment of the instant invention. This fourth embodiment is similar to the first embodiment, except that a permanent or removable microphone 208 is provided, together with the necessary electronics, to enable the device to be used to record the users voice on the memory card 24. In other words, in this embodiment, the headphone system 10 can selectively used to playback or record audio to the memory device 24. Thus, the microphone 208 allows the device to act as a speech-recording device, so that users can record their dictation. In this case, the device also contains a media writer, typically being the same element as the media reader, i.e. a single input/output element. To regulate the recording process, this embodiment has an additional record button preferably located near the top of the right front earpiece.

Also in this fourth exemplary embodiment, the controls are preferably positioned differently than in the first embodiment. This is done to accommodate users who may frequently record, rewind, play, and resume recording as they dictate. The controls in this embodiment are rearranged so that these common operations can be done with a single hand—the right hand in this embodiment. Specifically, on the left earpiece, controls are located as follows: Volume up/down on the back of the earpiece so they can be easily operated with the left thumb; the Power on/off control is located at the top of the earpiece; and the Forward Track and Backward Track controls are on the top and bottom front. On the right earpiece the controls are preferably positioned as follows: the Play/Pause control is located on the back of the earpiece toward the top so it may be conveniently operated by the end part of the thumb while the lower part of the thumb grips the earpiece during operation of the front controls; the record control, which must be depressed when Play is pressed to start recording, is located at the top of the front of the earpiece for easy operation by the index finger; and the Forward and Backward controls are positioned below the Record key. A “mark” button may also be provided to set an indication without starting/stopping the device to allow the user to later search and easily locate marked places on the tape, such as when the tape is later played back or processed on a computer or the like.

In addition, to achieve even more “hands free” operation, the device is preferably operable to and includes logic to analyze the input being recorded, identify unusually long pauses, and avoid recording them in long-term memory. This feature is achieved by recording all data in a temporary buffer in its internal memory. Before the data is transferred to longer term “permanent memory” (e.g., on the SmartMedia memory card in the exemplary embodiment), the device's processor analyzes the data to determine whether it reflects “dead” time of no speaking, or other meaningful sound. If it is deemed to be deadtime, then dead periods are shortened (such as to a fraction of their length, or to some fixed interval). A short “beep” or other audio signal may be used to indicate the passage of time. This allows a user to record dictation while both hands are occupied with another activity without having to be concerned about deactivating the recorder during quiet periods.

Of course, in any of the embodiments described above, the particular location of the elements described herein can be changed. For example, the left and right earpiece or headband functionality can be switched.

In accordance with another feature of the invention, the headphone system can be solar powered. In other words, solar cells could be provided on the headset to provide alternate or supplemental power from ambient light. Various other features may be added as well, such as a “sleep” state to conserve power during inactive times. As explained above, the system may also include encryption/decryption functionality so that the audio material may be encrypted/decrypted

In another embodiment of the invention, the playback equipment may also contains a radio receiver enabling it to receive broadcasts from sources away from the user. The device may then be provided with controls allowing the user to tune to different frequencies, and to receive either AM or FM radio, and also to make and receive radio and/or cellular telephone communication. Such communication may be analog or digital in nature.

In accordance with another embodiment of the invention, the headset also supports video, so that visual presentations can also be made to the user without requiring cables connecting the headphones to a playback device. In other words, the playback device may be provided with an appropriate video display and the memory media could be loaded with video data for display on the display by the playback device.

In any of the embodiments described above, especially those in which the controls are mounted on the headset, the controls can be embossed with tactile patterns or symbols making it easier for the user to identify them without actually seeing the controls. In addition, especially in embodiments in which the digital memory is not removable, the device may also include an interface for connecting the device to a source from which information can be loaded into the memory, and in embodiments with a microphone, downloaded from the memory. This may be useful even in embodiments in which the device uses removable memory, in the event that the user does not have another way to couple the memory cards to a communication system.

As explained above, the device is preferably powered by batteries, either conventional or specialized, and in various different preferred embodiments, these batteries may be permanently installed, or may be removable. Some embodiments may allow power to be generated through “solar” cells or other units which convert ambient or incident electromagnetic radiation into power used by the device. In addition, other embodiments may allow a variety a different power strategy—allowing permanent battery and/or replaceable battery and/or ambient electro-magnetic “power” cells as sources.

While the preferred forms and embodiments have been illustrated and described herein, various changes and modification may be made to the exemplary embodiment without deviating from the scope of the invention, as one skilled in the art will readily understand from the description herein. Thus, the above description is not meant to limit the scope of the appended claims beyond the true scope and sprit of the instant invention as defined herein.

What is claimed is:

1. A portable audio playback device, comprising:
A headset assembly having a first earpiece and a second earpiece interconnected by a headband, wherein the headset assembly is configured to be worn on the head of a user such that the earpieces are positioned over respective ears of the user;
at least one audio speaker positioned in at least one of the first earpiece and the second earpiece;
a storage device in the headset assembly for storing audio data;
memory accessing circuitry in the headset assembly for accessing the audio data in the storage device;
a controller in the headset assembly for sending the audio signals based on the audio data to the at least one speaker; and
a power supply in the headset assembly for powering the audio playback device.

2. The device of claim 1, wherein the storage device is a removable storage device.

3. The device of claim 2, wherein the storage device is a solid state digital storage media having digitally recorded audio information thereon.

4. The device of claim 2, wherein the storage device is an optical storage device.

5. The device of claim 2, wherein the storage device is an electronic memory.

6. The device of claim 2, wherein the storage device is a magnetic memory.

7. The device of claim 2, wherein the storage device is a flash memory.

8. The device of claim 1, wherein said first earpiece includes a storage device slot for removably receiving the storage device therein.

9. The device of claim 8, wherein the second earpiece houses the power supply.

10. The device of claim 9, wherein wiring is provided for interconnecting the power supply, speakers, controller and accessing circuitry, and at least some of said wiring extends through an interior of said headband.

11. A portable audio playback device, comprising:
A headset assembly having a first earpiece and a second earpiece interconnected by a headband, wherein the headset assembly is configured to be worn on the head of a user such that the earpieces are positioned over respective ears of the user;
at least one audio speaker positioned in at least one of the first earpiece and the second earpiece;
a storage device in the headset assembly for storing audio data;
memory reader in the headset assembly for accessing the audio data in the storage device;
a controller in the headset assembly for sending the audio signals based on the audio data to the at least one speaker;
a power supply in the headset assembly for powering the audio playback device; and
and at least one audio control assembly provided on the headset assembly and including a control button for use by the user in controlling the playback of the audio data.

12. The device of claim 11, wherein the at least one audio control assembly is located on one of said first earpiece and said second earpiece.

13. The device of claim 11, further including a plurality of audio control assemblies each including an associated control button providing a different control function for use by the user, wherein the audio control assemblies are each located on one of said first earpiece and said second earpiece.

14. The device of claim 13, wherein the audio control assemblies provide at least power on/off, stop/start, fast forward, fast reverse, and volume control functions.

15. The device of claim 11, wherein the at least one audio control assembly is located on said headband.

16. The device of claim 11, further including a plurality of audio control assemblies each including an associated control button providing a different control function for use by the user, wherein the audio control assemblies are located on the headband.

17. The device of claim 16, wherein the audio control assemblies provide at least power on/off, stop/start, fast forward, fast reverse, and volume control functions.

18. The device of claim 11, wherein the storage device is a removable storage device.

19. The device of claim 18, wherein the storage device is a solid state digital storage media having digitally recorded audio information thereon.

20. The device of claim 18, wherein the storage device is an optical storage device.

21. The device of claim 18, wherein the storage device is an electronic memory.

22. The device of claim 18, wherein the storage device is a magnetic memory.

23. The device of claim 18, wherein the storage device is a flash memory.

24. The device of claim 11, wherein said first earpiece includes a storage device slot for removably receiving the storage device therein.

25. The device of claim 24, wherein the second earpiece houses the power supply.

26. The device of claim 11, wherein wiring is provided for interconnecting the power supply, speakers, controller and memory reader, and at least some of said wiring extends through an interior of said headband.

27. A portable audio playback device, comprising:
A headset assembly having a first earpiece and a second earpiece interconnected by a headband, wherein the headset assembly is configured to be worn on the head of a user such that the earpieces are positioned over respective ears of the user;
at least one audio speaker positioned in at least one of the first earpiece and the second earpiece;
a storage device in the headset assembly for storing audio data;
memory accessing circuitry in the headset assembly for reading and writing audio data in the storage device;
a microphone connected to the headset assembly for receiving user voice input;
a controller in the headset assembly for sending the audio signals based on the audio data stored on the storage device to the at least one speaker, and for controlling writing of audio data based on the voice input to the storage device; and
a power supply in the head set assembly for powering the audio playback device.

28. The device of claim 27, wherein the storage device is a removable storage device.

29. A portable audio playback system, comprising:
A headset assembly having a first earpiece and a second earpiece interconnected by a headband, wherein the headset assembly is configured to be worn on the head of a user such that the earpieces are positioned over respective ears of the user, said headset further including at least one audio speaker positioned in at least one of the first earpiece and the second earpiece, and an audio signal receiver.
a playback unit remote from said headset unit including a storage device for storing audio data, memory accessing circuitry for accessing the audio data in the storage device, and a transmitter for transmitting wireless audio signals to the headset based on the audio data;
wherein the audio signals received by the headset assembly are sent to the at least one speaker so that they are heard by the user.

30. The device of claim 29, wherein the headset assembly further includes a microphone and a transmitter for transmitting wireless audio signals based on user voice input provided to the microphone, and said playback unit further includes a receiver for receiving the transmitted audio signals and recorder for recording audio data in the storage device based on the received audio signals.
